(19) United States
(12) Patent Application Publication
(10) Pub. No.: US 2005/0254081 A1
(43) Pub. Date: Nov. 17, 2005

(54) Direct printing method and apparatus

(75) Inventors: Seok Ryu, Suwon-si (KR); Kwang-chul Lee, Suwon-si (KR); Eun-hee Rhim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/127,145

(22) Filed: May 12, 2005

(30) Foreign Application Priority Data
May 12, 2004 (KR) 10-2004-0033522
Jul. 28, 2004 (KR) 10-2004-0059347

(51) Int. Cl. G06F 15/00

(52) U.S. Cl. 358/1.13; 358/1.15

(57) ABSTRACT

A direct printing method and for printing multimedia data including an image and text are provided. The direct printing method includes composing hyperlink information on image data to be printed by an image supplying apparatus and text using a predetermined markup language, transferring the markup document resulting from the composing to a printing apparatus directly connected with the image supplying apparatus via a predetermined interface to perform a direct printing job, and transferring font data corresponding to the text data to the printing apparatus in response to a request from the printing apparatus. Multimedia data including text and an image can be printed by performing the direct printing job.

### CROSS-REFERENCE TO RELATED APPLICATIONS

This application claims priority from Korean Patent Application Nos. 10-2004-0033522 and 10-2004-0059347 filed on May 12, 2004 and Jul. 28, 2004, respectively, in the Korean Intellectual Property Office, the disclosures of which are incorporated herein by reference in their entirety.

### BACKGROUND OF THE INVENTION

1. Field of the Invention

Apparatuses and methods consistent with the present invention relate to direct printing, and more particularly, to direct printing of multimedia data including an image and text.

2. Description of the Related Art

Along with the recent proliferation of digital photographing apparatuses (hereinafter, individually referred to as a “photographing apparatus”) such as digital cameras or mobile phones having an incorporated digital camera capable of photographing an image and converting the image into digital image data, technology has developed for printing this image.

In general, in order to print an image composed of digital image data, the digital image data should be transferred to a printing relay apparatus, for example, a personal computer (PC).

The printing relay apparatus to which the digital image data is transferred performs a series of image processing jobs for image printing, including determining the layout and resolution of an image to be printed according to a user's request.

Then, a printing apparatus receives this image information and printing conditions, and performs printing.

However, in recent years, a technology has been developed for performing direct printing using a photographing apparatus and a printing apparatus without requiring a printing relay apparatus, and this technology is referred to as “direct printing”.

As a result, a user is able to directly connect the photographing apparatus with the printing apparatus via a predetermined interface, for example, a universal serial bus (USB) interface, and directly print an image stored in the photographing apparatus.

However, conventional direct printing technology has allowed only image transfer and printing.

Accordingly, a need still exists for technology for printing multimedia data including an image and text as well as an image according to a user's request.

### SUMMARY OF THE INVENTION

The present invention provides a direct printing method and apparatus for printing multimedia data including an image and text.

According to an aspect of the present invention, there is provided a method of providing multimedia for direct printing, the method including composing hyperlink information on image data to be printed by an image supplying apparatus and text using a predetermined markup language, transferring the markup document resulting from the composing to a printing apparatus directly connected with the image supplying apparatus via a predetermined interface to perform a direct printing job, and transferring font data corresponding to the text.

According to another aspect of the present invention, there is provided a direct printing method including parsing a predetermined markup document received from an image supplying apparatus directly connected with a printing apparatus to perform a direct printing job, requesting for font data indicated by information on the font data of text set in the markup document, and printing the received font data of the text with the image included in the markup document resulting from the parsing.

According to a further aspect of the present invention, there is provided a image supplying apparatus including an interface unit transferring and receiving data by connecting a printing apparatus via a predetermined interface to perform a direct printing job, an encoder composing an image and text to be printed using a predetermined markup language, and a controller controlling transfer of the markup document resulting from the composing and the font data of the text in response to a request from the printing apparatus.

According to yet another aspect of the present invention, there is provided a printing apparatus including an interface unit transferring and receiving data by connecting an image supplying apparatus via a predetermined interface to perform a direct printing job, a decoder parsing a predetermined markup document received from the image supplying apparatus, a controller requesting for font data indicated by information on the font data set in the markup document, and a printing unit printing the text corresponding to the font data received according to the request by the controller with the image data included in the parsed markup document.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of a photographing apparatus according to an exemplary embodiment of the present invention;

FIG. 2 illustrates a document in which a printing format of multimedia data including an image and text is written in a markup language according to the exemplary embodiment of the present invention;

FIG. 3 illustrates an example of a style sheet including font data and a layout of image and text to be printed;

FIG. 4 is a block diagram of a printing apparatus according to another exemplary embodiment of the present invention;

FIG. 5 is a flowchart illustrating communication between the photographing apparatus and the printing apparatus according to an exemplary embodiment of the present invention;

FIG. 6 illustrates printing functional information transferred by the printing apparatus according to an exemplary embodiment of the present invention in a script format;

FIG. 7 illustrates printing job command JOBSTART in a script format according to an exemplary embodiment of the present invention;

FIG. 8 is a flowchart illustrating a communication sequence in which the printing apparatus obtains a markup document from the photographing apparatus, implemented using a PTP architecture;

FIG. 9 is a flowchart illustrating the operation of the photographing apparatus according to an exemplary embodiment of the present invention;

FIG. 10 is a flowchart illustrating the operation of the printing apparatus according to another embodiment of the present invention; and

FIG. 11 illustrates an image and text printed according to an exemplary embodiment of the present invention.

### DETAILED DESCRIPTION OF THE EXEMPLARY EMBODIMENTS

The present invention and methods of accomplishing the same may be understood more readily by reference to the following detailed description of exemplary embodiments and the accompanying drawings.

The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

The present invention will now be described more fully with reference to the accompanying drawings, in which exemplary embodiments of this invention are shown.

In the present invention, an image supplying apparatus means a device capable of performing a direct printing operation by transferring an image and text to be printed to a printing apparatus by directly accessing the printing apparatus via a predetermined interface unit.

Thus, not only a photographing apparatus but any device capable of storing image data, such as a personal digital assistant (PDA) or a mobile phone can serve as an image supplying apparatus.

The present invention will be described with reference to several exemplary embodiments by taking an example of a photographing apparatus as an exemplary image supplying apparatus, but the invention is not limited thereto. Other types of image supplying apparatus can be used for direct printing according to the present invention.

The present invention will now be described more fully with reference to the accompanying drawings, in which an exemplary embodiment of the invention is shown.

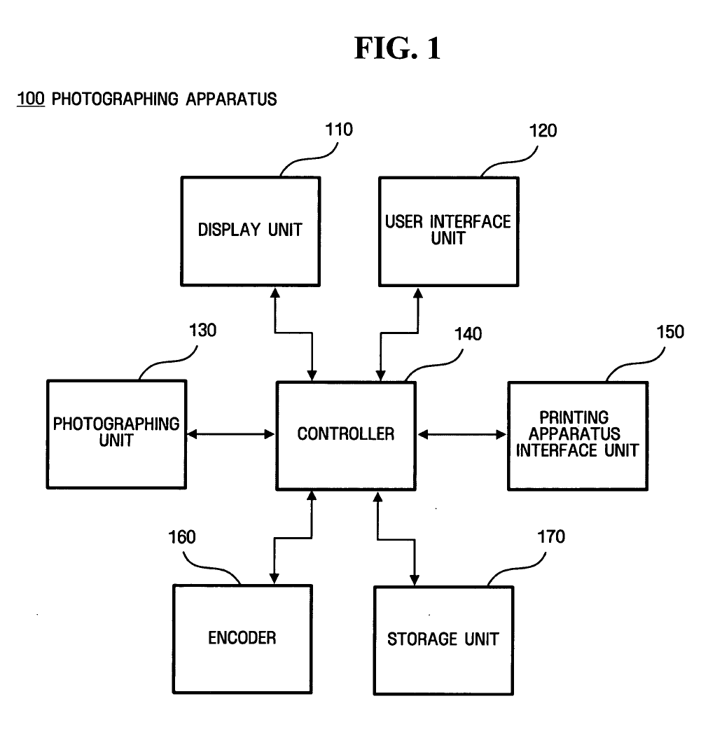

FIG. 1 is a block diagram of a photographing apparatus 100 according to an exemplary embodiment of the present invention.

The photographing apparatus 100 shown in FIG. 1 includes a display unit 110 that displays a printing status and a variety of photographing situations, a user interface unit 120 used in controlling the photographing apparatus 100, a photographing unit 130 that photographs an image and generates digital image data, a controller 140 that controls the overall operations of the various functional blocks of the photographing apparatus 100, a printing apparatus interface unit 150 that connects the photographing apparatus 100 to a printing apparatus, an encoder 160 that composes a printing format of multimedia data using a predetermined markup language, and a storage unit 170 that stores image data, a document in a markup language, or the like.

The display unit 110 displays photographing situations of the photographing apparatus 100, a photographed image, text, and the like inserted in the image by a user.

In addition, when the photographing apparatus 100 is connected to the printing apparatus 200 and performs a direct printing job, the display unit 110 displays printing conditions, printing progress, and the like.

Thus, the user can check images and text to be printed, and a direct printing procedure through the display unit 110.

The user interface unit 120 provides the user with means for controlling the photographing apparatus 100.

Specifically, the user interface unit 120 may include a keypad or a touch screen.

Thus, the user can control the photographing apparatus through the user interface unit 120 to perform a variety of photographing jobs.

Through the user interface unit 120 the user can also input text to be printed together with the image photographed by the photographing unit 130 or stored in the storage unit 170.

In addition, when the photographing apparatus 100 is connected to the printing apparatus and performs the direct printing job, the user can control a printing procedure like setting printing conditions or selecting an image to be printed.

The photographing unit 130 photographs an image according to a user's commands and converts the photographed image into digital image data.

Here, the digital image data is stored in the storage unit 170, and the image composed of the digital image data may be displayed on the display unit 110.

The controller 140 controls the operation of each functional block of the photographing apparatus 100.

In addition, the controller 140 generates and outputs a variety of commands or interprets the commands received from the printing apparatus to permit the photographing apparatus 100 to perform a direct printing job.

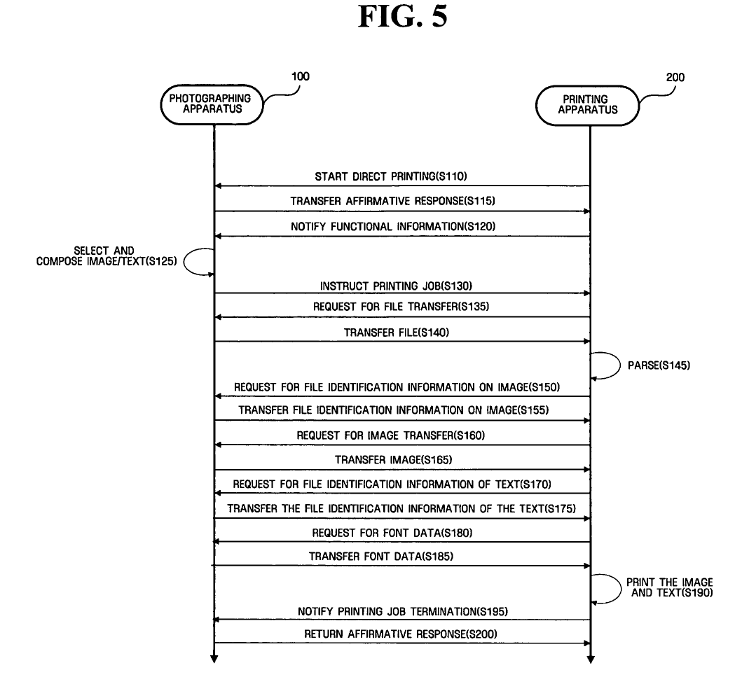

When the direct printing job is performed, the variety of commands processed by the controller 140 will be described later with reference to FIGS. 5 through 8.

The printing apparatus interface unit 150 transfers the variety of commands or data output from the controller 140 to the printing apparatus or receives the commands or data transferred from the printing apparatus.

The printing apparatus interface unit 150 may be connected to the printing apparatus 200 via a USB or IEEE 1394 wire interface, or via a Bluetooth wireless interface.

For example, when the photographing apparatus 100 is connected to the printing apparatus via a USB cable connection using the printing apparatus interface unit 150, the photographing apparatus 100 is a client and the printing apparatus 200 is a host.

Thus, the controller 140 of the photographing apparatus 100 serves as a storage server and a printer client for direct printing.

When the user controls the photographing apparatus 100 to print both the image and the text during direct printing, the encoder 160 composes hypertext information about the image and text using a predetermined markup language.

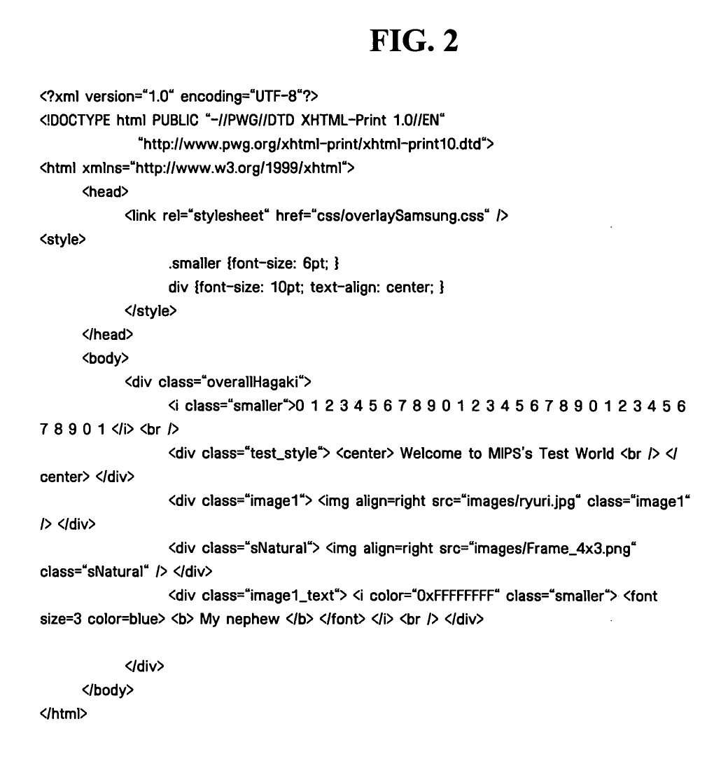

An example of a markup document composed by the encoder 160 is shown in FIG. 2.

FIG. 2 illustrates a document in which a printing format of multimedia data including an image and text is written using Extensible Hypertext Markup Language (XHTML) as an exemplary markup language according to the exemplary embodiment of the present invention.

As shown in FIG. 2, the text to be printed is “Welcome to MIPS's Test World” and an image to be printed together with the text is “ryuri.jpg” and “Frame_{—}4×3.png”, as detailed by the hyperlinks.

In this case, the hyperlink of the image may be set to an image between the photographing apparatus 100 and the printing apparatus 200 or file identification information used in a data exchange protocol.

For example, if an image or data exchange between the photographing apparatus 100 and the printing apparatus is performed using Picture Transfer Protocol (PTP), i.e., “Picture Transfer Protocol for Digital Still Photography Devices”, PIMA 15740:2000, 5 Jul. 2000, the hyperlink can be replaced with file identification information (information on an object) instead of “ryuri.jpg”.

The storage unit 170 stores digital image data processed by the photographing unit 130, and the markup document composed by the encoder 160.

File identification information, hereinafter referred to as a “file handle”, used in the image or data exchange protocol between the photographing apparatus 100 and the printing apparatus, may be mapped to data stored in the storage unit 170.

The file handle may be set by the controller 140 or the printing apparatus 200.

When the user sets a layout for printing an image and text through the user interface unit 120, layout information may be transferred to the printing apparatus 200.

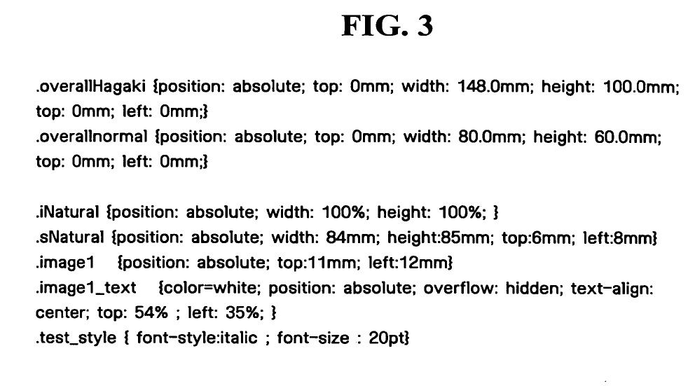

An example of a style sheet including such layout is shown in FIG. 3.

The controller 140 may compose this style sheet together with image hyperlink information and text using the encoder 160.

The style sheet may include font information about the text input by the user.

The font information may be set as file identification information used in the data exchange protocol between the photographing apparatus 100 and the printing apparatus 200.

For example, in the style sheet shown in FIG. 3, the font information contains a font style of “Italic” and a font size of “20 pt”.

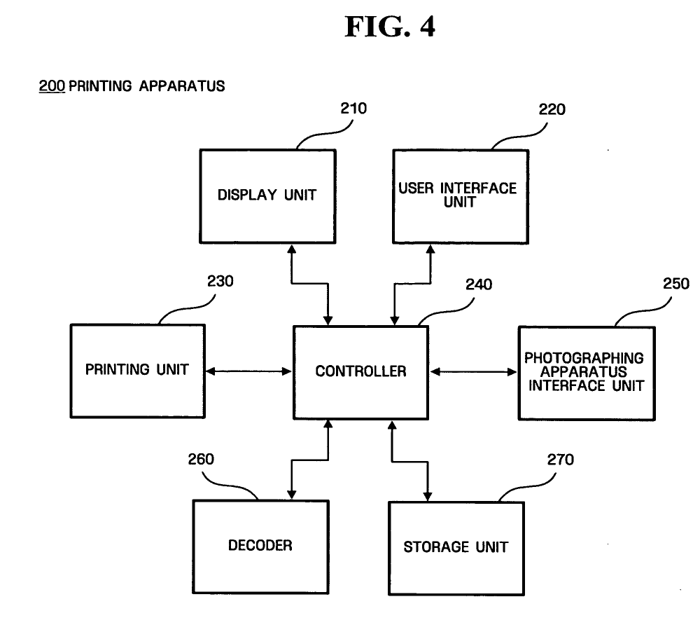

FIG. 4 is a block diagram of a printing apparatus 200 according to an exemplary embodiment the present invention.

As shown in FIG. 4, the printing apparatus 200 includes a display unit 210 that displays the printing status, a user interface unit 220 for controlling the printing apparatus 20, a printing unit 230 that prints an object processed by a controller 240, the controller 240 for controlling the operation of each functional block of the printing apparatus 200, a photographing interface unit 250 that connects the printing apparatus 200 to the photographing apparatus 100, a decoder 260 that parses a markup document received from the photographing apparatus 100, and a storage unit 270 that stores a description to be printed.

The display unit 210 displays a variety of photographing situations of the printing apparatus 200. A printing status for the case where the printing apparatus 200 is connected to the photographing apparatus 100 to perform a direct printing job may be displayed on the display unit 110 of the photographing apparatus 100.

In this case, the display unit 210 of the printing apparatus 200 may display that the direct printing job is being performed.

However, the present invention is not limited to this, and even though the direct printing job is being performed, the display unit 210 may display printing conditions, statuses, or the like.

The user interface unit 220 provides the user with means for controlling the printing apparatus 200. Specifically, the user interface unit 220 may include a keypad or a touch screen.

Thus, the user can set a variety of printing conditions, for example, quality, paper size, paper type, image type, or the like, through the user interface unit 220.

When the printing apparatus 200 is connected to the photographing apparatus 100 and performs a direct printing job, setting of the printing conditions may be controlled by the user interface unit 120 of the photographing apparatus 100.

In this case, the user interface unit 220 of the printing apparatus 200 may not respond to user input.

However, the present invention is not limited to this, and the user can control the printing apparatus 200 though the user interface unit 220. For example, the user can set printing conditions even when the direct printing job is being performed.

The printing unit 230 prints a target object, which has been processed by the controller 240.

The controller 240 controls the operation of each functional block of the printing apparatus 200. In addition, the controller 240 generates and provides a variety of commands or interprets commands received from the photographing apparatus 100 so that the printing apparatus 200 can perform a direct printing job.

The variety of commands processed by the controller 240 will be described later with reference to FIG. 5.

The controller 240 may also allow setting of printing conditions or displaying of printing status to be performed by the above-described photographing apparatus 100 during the direct printing job.

In addition, when the markup document received from the photographing apparatus 100 is parsed by the decoder 260, the controller 240 retrieves the printing format of the multimedia data and outputs printing information to the printing unit 230.

The photographing apparatus interface unit 250 transfers the commands or data output from the controller 240 to the photographing apparatus 100 or receives the commands or data transferred from the photographing apparatus 100.

The photographing apparatus interface unit 250 may be connected to the printing apparatus 200 through a USB or IEEE 1394 wire interface, or through a Bluetooth wireless interface.

For example, when the printing apparatus 200 is connected to a photographing apparatus interface unit 250 via a USB cable, the photographing apparatus 100 is a client and the printing apparatus 200 is a host. Thus, the controller 240 of the printing apparatus 200 serves as a storage server and a printer client for direct printing.

The decoder 260 parses the markup document transferred from the photographing apparatus 100.

Printing information about multimedia data including an image and text is included in the markup document.

As such, the controller 240 can retrieve the printing format of the multimedia data.

The storage unit 170 stores printing information and a variety of data received from the photographing apparatus 100.

FIG. 5 is a flowchart illustrating communication between a photographing apparatus and a printing apparatus according to another exemplary embodiment of the present invention.

Specifically, FIG. 5 illustrates a procedure of exchanging commands and data between the controller 140 of the photographing apparatus 100 and the controller 240 of the printing apparatus 200.

When the printing apparatus 200 and the photographing apparatus 100 are connected to each other via a predetermined interface, a direct printing application installed in the printing apparatus 200 and the photographing apparatus 100 is executed and a direct printing job is performed.

In operation S110, the printing apparatus 200 issues a direct printing start command to implement a direct printing mode.

If the direct printing application is installed in the photographing apparatus 100, in operation S115, the photographing apparatus 100 transfers an affirmative response.

After receiving the affirmative response, the printing apparatus 200 notifies the photographing apparatus 100 of its functions in operation S120.

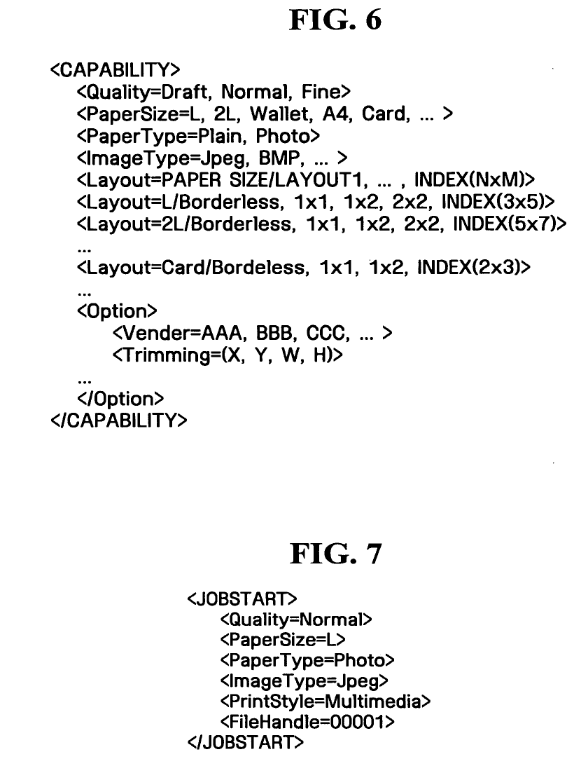

The functional information may be transferred to the photographing apparatus 100 in a script format and an exemplary embodiment thereof is shown in FIG. 6.

As shown in FIG. 6, the functional information may include information on a variety of printing functions of the printing apparatus 200, such as paper type, size, and quality, image type, layouts for specific paper sizes, or other options.

After receiving the functional information, the user of the photographing apparatus 100 determines whether printing is to be performed using any of functions of the printing apparatus 200, and selects image and text to be printed in operation S125.

In this case, the user can also determine other printing options e.g., a font of the text to be printed.

When the user desires to print the image with text, the photographing apparatus 100 can compose the printing format using a markup language, as described above.

Here, a style sheet containing information on the layout set by the user may be composed.

If the image and text to be printed are selected and printing conditions are determined, in operation S130, the photographing apparatus 100 issues a printing job command to the printing apparatus 200.

When issuing the printing job command, the photographing apparatus 100 can also transfer printing conditions and file identification information (a mapping in the markup document).

In this case, the file identification information may be a file handle. The printing apparatus 200 may request the photographing apparatus 100 to transfer specific data using the received file identification information.

An exemplary embodiment of a printing job command JOBSTART in a script format is shown in FIG. 7.

As shown in FIG. 7, during the printing job command, the photographing apparatus 100 can transfer printing conditions determined by the user, such as paper quality and size, and file identification information for identifying a file to be printed, that is, a file handle FileHandle.

When issuing a printing job command, the photographing apparatus 100 can also transfer information on a printing style PrintStyle. In the present invention, a printing style is information indicating whether only an image is to be printed or multimedia data including an image and text is to be printed. An example thereof is shown in Table 1.

TABLE 1
Examples of Printing Styles

| Printing Style | Description of Printing Job |
|---|---|
| ImageOnly | Print image only |
| Multimedia | Print image with text |

The printing apparatus 200 can determine whether a received file for printing is digital image data or a markup document, through the printing style. If the received file is a markup document, the controller 240 of the printing apparatus 200 can parse the received file using the decoder 260.

After receiving the printing job command, the printing apparatus 200 requests the photographing apparatus 100 to transfer the file identified in the file handle, in operation S135.

After receiving the file transfer request, the photographing apparatus 100 transfers this file to the printing apparatus 200 in operation S140.

When the file transferred from the photographing apparatus 100 is a markup document, the printing apparatus 200 parses the file using the decoder 260 in operation S145.

The printing apparatus 200 can determine the printing format parsed file. If the received markup document includes a layout and font data, as shown in FIG. 2, the printing apparatus 200 requests the photographing apparatus 100 to transfer file identification information identified in the hyperlink included in the markup document, in operation S150.

In operation S155, the photographing apparatus 100 transfers this file identification information in response to the request from the printing apparatus 200. The file identification information may be a file handle, as previously described.

After receiving the file identification information, if the printing apparatus 200 requests the photographing apparatus 100 to transfer an image to be printed in operation S160, the photographing apparatus 100 transfers image data mapped to the corresponding file identification information in operation S165.

If a style sheet such as the one shown in FIG. 4 is included in the markup document received by the printing apparatus 200, the printing apparatus 200 requests file identification information identified in the font data of the style sheet in operation S170. The file identification information may be a file handle, as previously described.

Then, the photographing apparatus 100 transfers this file identification information to the printing apparatus 200, in operation S175.

After acquiring the file identification information of the text to be printed, the printing apparatus 200 requests font data of the text to be printed using this file identification information in operation S180. Then, in operation S190, the photographing apparatus 100 prints the image and text according to the parsing result of operation S145.

If only an image is to be printed, that is, if the printing style is set to ImageOnly in the printing job command of operation S130, operations S135 through S155 can be omitted.

Thus, in such a case, the printing apparatus 200 prints the image in the same manner as a conventional printing apparatus.

If the printing job requested by the photographing apparatus 100 is terminated, in operation S195, the printing apparatus 200 notifies the photographing apparatus 100 of printing job termination, and in operation S200, the photographing apparatus 100 returns an affirmative response to the printing apparatus 200. In this manner, the direct printing job is completed.

If the markup document received from the photographing apparatus 100 includes hyperlinks to a plurality of images, font data information on a plurality of text, or file identification information on other multimedia data, operations S135 through S165 are repeatedly performed so that the printing apparatus 200 can obtain the images and text required for printing.

Even when hyperlinks to an image and text are not composed using a markup language, the photographing apparatus 100 transfers the image and font data of the text in a manner similar to that described above.

Communication between the photographing apparatus 100 and the printing apparatus 200, as shown in FIG. 5, may be implemented to conform with an image, text, or data transfer protocol. In an exemplary embodiment of the present invention, data exchange between the photographing apparatus 100 and the printing apparatus 200 is accomplished using PTP as described in the following.

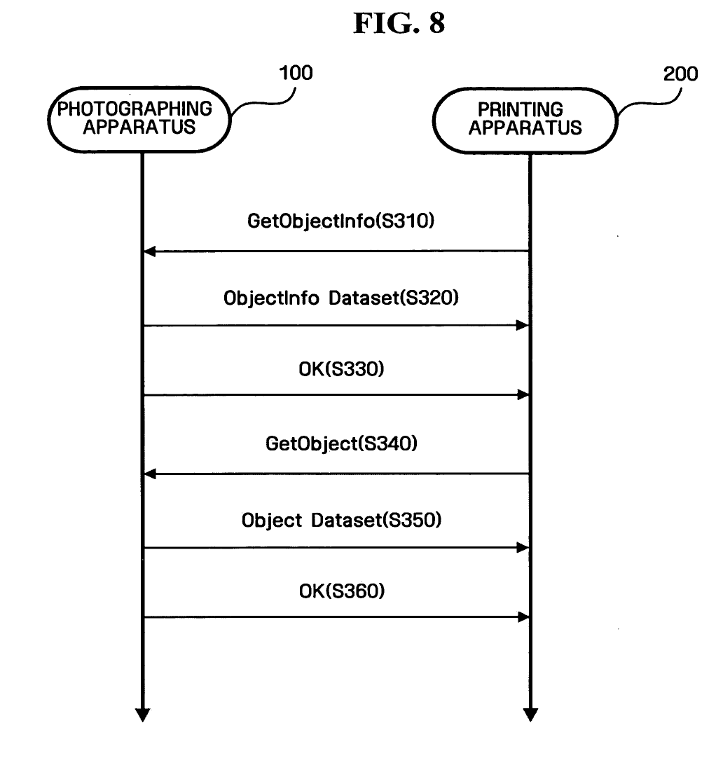

FIG. 8 is a flowchart illustrating a communication sequence in which the printing apparatus 200 obtains a markup document from the photographing apparatus 100 according to the PTP architecture.

In operation S310, the printing apparatus 200 requests the photographing apparatus 100 to transfer file identification information on an object of document data stored in the photographing apparatus 100 through a GetObjectInfo command. In operation S320, the photographing apparatus 100 transfers a dataset on the object (ObjectInfo Dataset) to the printing apparatus 200.

If the photographing apparatus 100 notifies the printing apparatus 200 that the photographing apparatus 100 is ready to perform a another job through an affirmative response (operation S330), the printing apparatus 200 requests the photographing apparatus 100 to transfer the object (markup document in the exemplary embodiment) identified by object information obtained in operation S320 to the photographing apparatus 100 through a GetObject command.

In operation S350, the photographing apparatus 100 transfers the Object Dataset (a markup document) requested by the printing apparatus 200.

If the object information is transferred during the printing job command of operation S130, operations S310 through S330 may be skipped.

Likewise, operations S150 through S185, in which the printing apparatus 200 obtains image data and font data from the photographing apparatus 100 to perform a printing job, may be implemented using PTP.

In addition, command and data transfer between the photographing apparatus 100 and the printing apparatus shown in FIG. 5 may also be implemented using PTP. A description of each operation is made in detail in Japanese Patent Laid-open Publication No. 2004-64740 entitled “Printing System, and Control Method Thereof and Photo-Direct Printer Apparatus”. Thus, the description of another communication sequence implemented using PTP and shown in FIG. 5 is omitted.

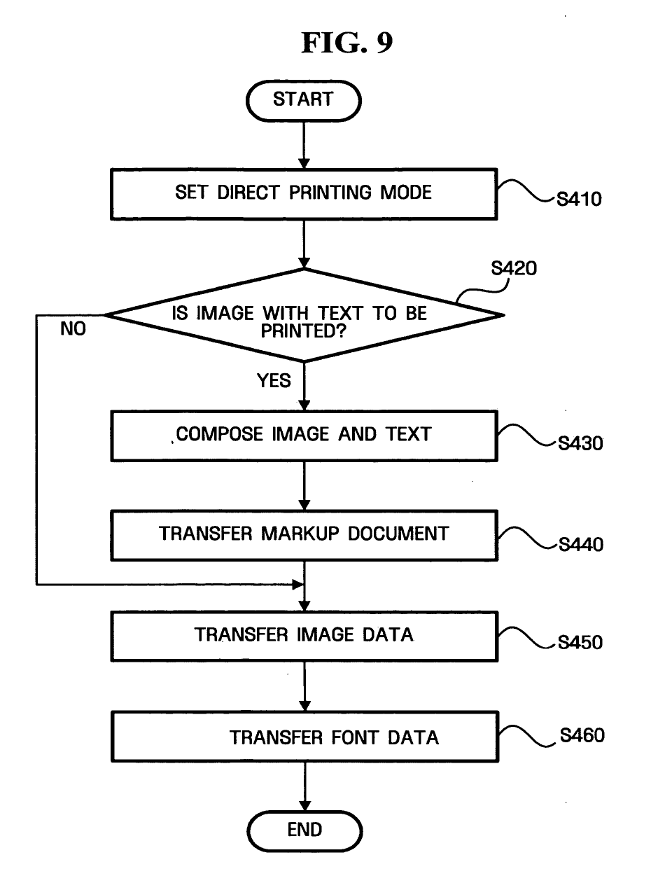

FIG. 9 is a flowchart illustrating the operation of the photographing apparatus according to the present invention.

In operation S410, if the photographing apparatus 100 is connected to the printing apparatus 200 via a predetermined interface and is set to a direct printing mode, in operation S420 it is determined whether a user requests a printout of multimedia data.

If a printout of multimedia data is requested, in operation S430, the encoder 160 of the photographing apparatus 100 uses a predetermined markup language to compose hyperlink information of an image and text to be printed. An example of the markup document composed by the encoder 160 has been described above with reference to FIG. 2.

If a markup document is generated, the photographing apparatus 100 transfers the markup document to the printing apparatus 200 in operation S440. If the printing apparatus 200 requests the photographing apparatus 100 to transfer an image to be printed using hyperlink information about the image included in the markup document, the photographing apparatus 100 transfers the image in operation S450.

In addition, if the printing apparatus 200 requests the photographing apparatus 100 to transfer font data of text to be printed using the information on font data included in the style sheet of the markup document, the photographing apparatus 100 transfers corresponding font data in operation S450.

If it is determined that only an image is to be printed in operation S420, the printing apparatus 200 prints the image in the same manner as the conventional printing apparatus.

Implementation of the direct printing job processed by the photographing apparatus 100 has been previously described in detail with reference FIGS. 5 through 8.

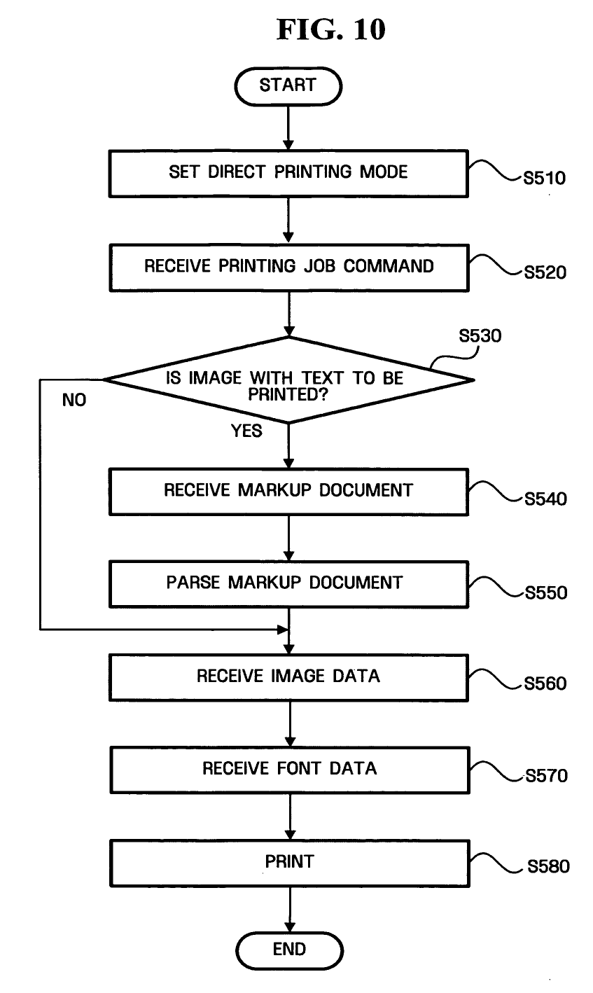

FIG. 10 is a flowchart illustrating the operation of a printing apparatus according to the present invention.

In operation S510, if the printing apparatus 200 connected to the photographing apparatus 100 via a predetermined interface and is set to a direct printing mode and then receives a printing job command from the photographing apparatus 100 (operation S520), the printing apparatus 200 performs a direct printing job.

In operation S530, the printing apparatus 200 determines whether multimedia data is to be printed by analyzing a received printing job command.

If multimedia data is to be printed, the printing apparatus 200 receives a markup document indicating a printing format of the multimedia data in operation S540 and parses the markup document using the decoder 260 in operation S550.

In operation S560, if the printing apparatus 200 requests the photographing apparatus 100 to transfer the image detailed in the hyperlink of the parsed markup document and receives image data thereof, and the printing apparatus 200 prints the multimedia data according to the parsed result.

In addition, in operation S570, the printing apparatus 200 requests the photographing apparatus 100 to transfer font data using the information on the font data contained in the style sheet of the markup document, and then receives the font data.

In operation S580, the printing apparatus 200 prints the multimedia data according to the parsing result.

If it is determined that only an image is to be printed in operation S430, the printing apparatus 200 prints the image in the same manner as the conventional printing apparatus.

Implementation of the direct printing job processed by the printing apparatus 200 has been previously described in detail with reference FIGS. 5 through 8.

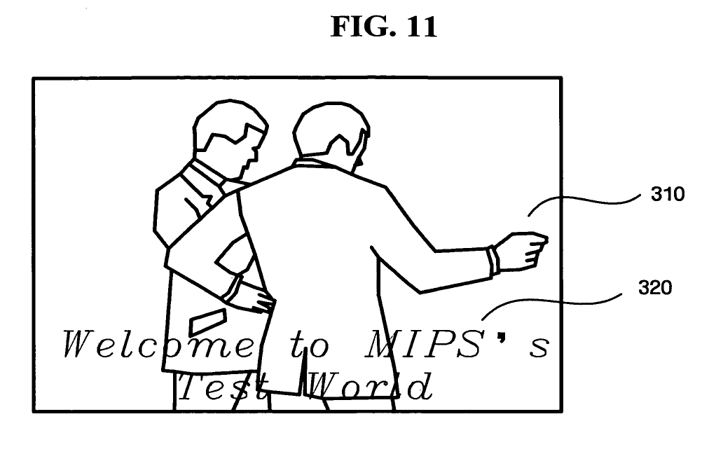

As shown in FIG. 11, an image 310 and text 320 received from the photographing apparatus 100 can be printed together. The font of the printed text 320 may be determined by the font data received from the photographing apparatus 100.

In the exemplary embodiment, the font of the printed text 320 has a style of “Italic” and a size of “20 pt”, as shown in the style sheet shown in FIG. 4.

As described above, in the direct printing method and apparatus according to the present invention, when a direct printing job from a photographing apparatus to a printing apparatus is performed, multimedia data including text and an image can be printed.

In conclusion, those skilled in the art will appreciate that many variations and modifications can be made to the exemplary embodiments without substantially departing from the principles of the present invention. Therefore, the disclosed exemplary embodiments of the invention are used in a generic and descriptive sense only and not for purposes of limitation.

1. A method of providing multimedia for direct printing, the method comprising:
composing with a markup language hyperlink information on image data and text to be printed by an image supplying apparatus, using;
transferring a markup document resulting from the composing to a printing apparatus directly connected to the image supplying apparatus via a predetermined interface to perform a direct printing job; and
transferring font data corresponding to the text to the printing apparatus in response to a request from the printing apparatus.

2. The method of claim 1, wherein the composing of the hyperlink information comprises composing the hyperlink information on the image data and the text to be printed together with a style sheet in which a layout for printing the image data and the text is set.

3. The method of claim 2, wherein the transferring of the font data comprises:
transferring file identification information in response to a first request from the printing apparatus that requests the photographing apparatus to transfer the file identification information mapped to information on the font data contained in the style sheet; and
transferring the font data to the printing apparatus in response to a second request from the printing apparatus that requests the photographing apparatus to transfer the font data using the file identification information.

4. The method of claim 3, wherein the file identification information complies with an image transfer protocol utilized by the printing apparatus and the image supplying apparatus.

5. A direct printing method comprising:
parsing a markup document received from an image supplying apparatus directly connected to a printing apparatus to perform a direct printing job;
requesting font data indicated by information on the font data set in the markup document; and
printing the font data of the text along with an image included in the markup document resulting from the parsing.

6. The direct printing method of claim 5, wherein the information on the font data includes layout information representing a print style of the image and the text.

7. The direct printing method of claim 6, wherein the requesting the font data comprises:
requesting file identification information mapped to the font data indicated by the information on the font data; and
requesting the font data using the file identification information.

8. The direct printing method of claim 7, wherein the file identification information complies with an image transfer protocol utilized by the printing apparatus and the image supplying apparatus.

9. An image supplying apparatus comprising:
an interface unit which transfers and receives data by connecting to a printing apparatus via a predetermined interface to perform a direct printing job;
an encoder which uses a markup language for composing an image and text to be printed; and
a controller which controls transfer of a markup document resulting from the composing of the image and the text and the font data of the text in response to a request from the printing apparatus.

10. The image supplying apparatus of claim 9, wherein the encoder composes the image and the text with a style sheet containing layout information representing a print style of the image and the text and the font data of the text.

11. The image supplying apparatus of claim 10, wherein the information on the font data complies with an image transfer protocol utilized by the printing apparatus and the image supplying apparatus.

12. The image supplying apparatus of claim 11, wherein the transfer of the font data is a transfer of the file identification information in response to a first request from the printing apparatus that requests the photographing apparatus to transfer file identification information mapped to the image data indicated by the information on the font data, and the transfer of the font data is made in response to a second request for the font data using the file identification information.

13. A printing apparatus comprising:
an interface unit which transfers and receives data by connecting to an image supplying apparatus via a predetermined interface to perform a direct printing job;
a decoder which parses a markup document received from the image supplying apparatus;
a controller which requests font data indicated by information on the font data set in the markup document; and
a printing unit which prints text corresponding to the font data, and image data included in the markup document.

14. The printing apparatus of claim 13, wherein the markup document includes a style sheet containing layout information representing a print style of the image and text and the font data of the text.

15. The printing apparatus of claim 14, wherein the style sheet contains information on the font data.

16. The printing apparatus of claim 15, wherein the information on the font data complies with an image transfer protocol utilized by the printing apparatus and the image supplying apparatus.

17. The printing apparatus of claim 16, wherein the request for the font data is a request for a transfer of the file identification information mapped to the font data indicated by the information on the font data, the request being made using the received file identification information.
